(19) United States
(12) Patent Application Publication
(10) Pub. No.: US 2026/0222055 A1
(43) Pub. Date: Jul. 30, 2026

(54) OSCILLATOR PHASE NOISE CALIBRATION

(71) Applicant: Viasat, Inc., Carlsbad, CA (US)

(72) Inventor: Charles M. LUKE, Cumming, GA (US)

(21) Appl. No.: 19/147,600

(22) PCT Filed: Jan. 13, 2023
(86) PCT No.: PCT/US2023/010748

§ 371 Date: Jul. 11, 2025

(51) Int. Cl. H04B 7/185; H04B 17/11; H04B 17/21

(52) U.S. Cl. CPC H04B 7/18513; H04B 7/18517; H04B 17/11; H04B 17/22

(57) ABSTRACT

Methods, systems, and devices for communication are described. A carrier signal may be generated by multiple oscillators, where the carrier signal may be used for communicating a communication stream. A time period during which a tolerance for noise in a local oscillator is reached may be determined. The time period may include a duration when an antenna is being directed toward an incoming satellite, a duration when a reduced-order modulation is configured for the communication stream, a duration when the multiple oscillators are not in use, and the like. The multiple oscillators may be calibrated during the time period.

### CROSS REFERENCE

The present application is a 371 national phase filing of International Patent Application No. PCT/US2023/010748 by LUKE entitled, “OSCILLATOR PHASE NOISE CALIBRATION”, filed Jan. 13, 2023, which is assigned to the assignee hereof and hereby incorporated by reference in its entirety.

### BACKGROUND

The following relates generally to communications, including oscillator phase noise calibration.

Communications devices may communicate with one another using wired connections, wireless (e.g., radio frequency (RF)) connections, or both. Wireless communications between devices may be performed using a wireless spectrum that has been designated for a service provider, wireless technology, or both. In some examples, the amount of information that can be communicated via a wireless communications network is based on an amount of wireless spectrum designated to the service provider, an amount of frequency reuse within the region in which service is provided, and spectral efficiency of communications using the wireless spectrum. Wireless communications generally involves modulating information onto carrier frequencies, where an increase in spectral efficiency may be obtained using higher modulation orders. However, higher order modulation techniques are more sensitive to noise (e.g., phase noise) and thus present challenges for wireless communications systems to use effectively.

### SUMMARY

Configurations and techniques for communications are described. A carrier signal may be generated using multiple oscillators, where the carrier signal may be used for communicating a communication stream. A time period during which a tolerance for noise in a local oscillator is relaxed (e.g., increased) may be identified. The time period may include a duration when an antenna is being directed toward an incoming satellite, a duration when a reduced-order modulation is configured for the communication stream, a duration when the multiple oscillators are not in use, and the like. The multiple oscillators may be calibrated during the time period.

### BRIEF DESCRIPTION OF THE DRAWINGS

FIG. 1 shows an example of a system that supports oscillator phase noise calibration in accordance with examples as disclosed herein.

FIG. 2 shows an example of a subsystem that supports oscillator phase noise calibration in accordance with examples as disclosed herein.

FIG. 3 shows an example of a controller that supports oscillator phase noise calibration in accordance with examples as disclosed herein.

FIG. 4 shows an example of a set of operations for oscillator phase noise calibration in accordance with examples as disclosed herein.

FIG. 5 shows an example of a controller that supports oscillator phase noise calibration in accordance with examples as disclosed herein.

FIG. 6 shows an example of a controller that supports oscillator phase noise calibration in accordance with examples as disclosed herein.

FIGS. 7 and 8 show flowcharts showing methods that support oscillator phase noise calibration in accordance with aspects of the present disclosure.

### DETAILED DESCRIPTION

As communications use higher frequencies and support higher data rates, noise tolerance (such as tighter limitations on phase noise) may decrease—e.g., as higher-order modulation is used. In some examples, dielectric resonator oscillators (DROs) are used to improve noise characteristics for a communications system. However, DROs may be expensive (e.g., relative to integrated circuit (IC) oscillators). Also, DROs may be packaged in a puck form that is adhered to an antenna and, in some examples, may experience adhesion failures.

To improve a noise performance of a communication system without using DROs, multiple IC oscillators may be used together to generate a single local oscillator signal for communication circuitry. By combining the local oscillator signals of the multiple IC oscillators, a single local oscillator signal with improved phase noise—e.g., because the main component of the local oscillator signals generated by the IC oscillators may coherently combine while the phase noise component of the local oscillator signal may noncoherently combine. However, to maintain the improved phase noise characteristics for a multi-IC oscillator circuit, calibration procedures to maintain the phase alignment of the IC oscillators may be performed (e.g., periodically, at least once in a set duration, etc.).

One option for phase calibration may include rotating the phase of one IC oscillator relative to another IC oscillator and comparing the signals until the phase is aligned (e.g., using signal magnitude). However, communications may be impaired while the calibration procedure is performed (e.g., due to the increased phase noise generated during the calibration procedure). Another option for phase calibration may include computing the phases of different IC oscillators and changing the determined phases of one or more of the individual IC oscillators so that the phases of the IC oscillators become aligned. Since phase measurements may be performed relative to a reference phase, aligning the phase of the IC oscillators may include individually turning on each of the IC oscillators and comparing a phase of the enabled oscillator to a reference phase. Because a portion of the oscillators may be turned off during alignment, there may be a degradation in the performance of the multi-IC oscillator. Thus, this option may be associated with an increased cost and complexity relative to performing a phase rotation search using amplitude.

To enable efficient calibration of multi-IC oscillators while reducing disruption to communications, the calibration procedure may be performed during periods in which phase noise tolerances for a communications system, multi-IC oscillator, or both, are relaxed—e.g., when communications signals are not being received, when the multi-IC oscillator is not being used, during periods of reduced demand, when a lower-order modulation is configured, etc.

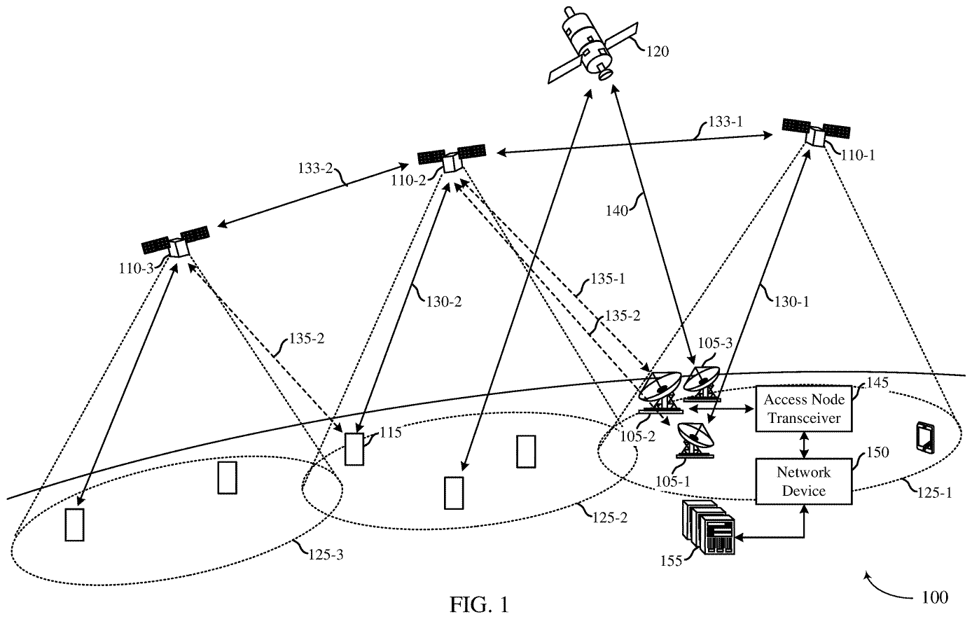

FIG. 1 shows an example of a system that supports oscillator phase noise calibration in accordance with examples as disclosed herein.

The system 100 may include access nodes (such as the first access node 105-1), low earth orbit (LEO) satellites (such as the first LEO satellite 110-1), user terminals (such as the user terminal 115), and geostationary orbit (GEO) satellites (such as the GEO satellite 120). The system 100 may also include medium earth orbit (MEO) satellites (not shown) that are positioned in orbits located between low earth orbits and geostationary orbits. In some examples, an access network may include the LEO satellites to provide an access point to the access network across a geographic region, where the LEO satellites may include overlapping coverage areas (such as the first coverage area 125-1, the second coverage area 125-2, and the third coverage area 125-3) that move across a surface of the earth. The user terminals may be located within different coverage areas and may access the access network using respective LEO satellites. In some examples, the LEO satellites relay communication signals amongst one another to reach devices (e.g., access nodes) that are located outside a respective coverage area. Additionally, or alternatively, the access network may include the GEO satellites to provide an access point to the access network. The LEO satellites, GEO satellites, or both, may relay communication signals received from the user terminals to the access nodes, and vice versa.

The access nodes may provide a link to one or more data networks 155, which may be the Internet, a communication network, or the like. The access nodes may receive, via the LEO satellites, GEO satellites, or both, the communication signals from the user terminals. The access nodes may also transmit, via the LEO satellites, GEO satellites, or both, communication signals to the user terminals. In some examples, the access node transceiver 145 may process the communication signals received at the access nodes—e.g., may downconvert, demodulate, and decode the communication signals. The access node transceiver 145 may also process the communication signals to be transmitted from the access nodes—e.g., may upconvert, encode, and modulate the communication signals. The network device 150 may interface with the one or more data networks 155.

In some examples, the access network may support a communication stream (e.g., a video stream, an IP call, etc.) between the user terminal 115 and the data network 155. For example, the user terminal 115 may establish the second LEO link 130-2 with the second LEO satellite 110-2 and send a communication signal to the second LEO satellite 110-2 via the second LEO link 130-2. The second LEO satellite 110-2 may relay the communication signal to the first LEO satellite 110-1 via the first backhaul link 133-1. And the first LEO satellite 110-1 may relay the communication signal to the first access node 105-1. Based on receiving the communication signal at the first access node 105-1, the access node transceiver 145 may receive and decode the communication signal, and the network device 150 may route the decoded data to its intended destination. Similarly, the first access node 105-1 may transmit a communication signal to the user terminal 115 via the satellites and satellite links, and the communications signals exchanged between the user terminal 115 and the first access node 105-1 may be a part of a communication stream for the user terminal 115.

For an example LEO-based communication, the first access node 105-1 may communicate a communication stream (e.g., for the user terminal 115) using a first set of satellites (e.g., the first LEO satellite 110-1 and the second LEO satellite 110-2) and a first link (e.g., the first LEO link 130-1) during a first period and using a second set of satellites (e.g., the second LEO satellite 110-2 and the third LEO satellite 110-3) and a handover link (e.g., the second handover link 135-2) during a second period—e.g., because the coverage areas of the satellites change over time. To support communications, the first access node 105-1 may follow (e.g., using a positioner) the first satellite (e.g., the first LEO satellite 110-1) until the first satellite leaves the horizon and may then be oriented in the direction of the second satellite (e.g., the second LEO satellite 110-2) as the second satellite enters the horizon. The period during which the first access node 105-1 is reoriented toward the second satellite may be referred to as a prepass duration. As part of the prepass operation, the communication stream may be interrupted while the first access node 105-1 switches from the first link to the handover link.

In another example, to avoid interruptions to a communication stream, the first access node 105-1 may communicate a communication stream (e.g., for the user terminal 115) using a first set of satellites (e.g., the first LEO satellite 110-1 and the second LEO satellite 110-2) and a first link (e.g., the first LEO link 130-1) during a first period. And a different access node (e.g., the second access node 105-2) may use a different handover link (e.g., the first handover link 135-1) to communicate the communication stream (e.g., for the user terminal 115) using the second set of satellites during a second period—e.g., during a handover operation between LEO satellites. As part of establishing the handover link, the second access node 105-2 may be reoriented (e.g., by a positioner) from a second horizon into the direction of the second satellite (e.g., the second LEO satellite 110-2) as the second satellite enters the opposing horizon. The period during which the second access node 105-2 is being repositioned to be oriented toward the second LEO satellite may be referred to as a retrace period. Accordingly, after or around the time the first satellite (e.g., the first LEO satellite 110-1) loses a communication path to the first access node 105-1, the second access node 105-2 may establish a communication path to the second satellite (e.g., the second LEO satellite 110-2), and the communication stream (e.g., for the user terminal 115) may be transferred to a new communication path that excludes the first satellite (e.g., a communication path that includes the second LEO satellite 110-2 and, in some examples, the third LEO satellite 110-3). After establishing the communication path, an orientation of the second access node 105-2 may track the position of the second satellite as it moves overhead.

In some examples, to support communications, the access node transceiver 145 may include a first oscillator (which may be referred to as a local oscillator) that is configured to generate a first local oscillator signal for communication circuitry and a second oscillator that is configured to generate a backup local oscillator signal for the communication circuitry.

The communication signals exchanged between the user terminal 115 and the first access node 105-1 may use a relatively high carrier frequency (e.g., frequencies above 1 GHz), and may support high data rates (e.g., data rates such as higher than 10 Mbps or higher than 100 Mbps), or both. To support such data rates, communication signals may be generated based on modulating data with a higher-order modulation (e.g., 64-QAM, 128-QAM, 256-QAM, etc.). Based on generating communication signals with the higher carrier frequencies, higher data rates, or both, a noise tolerance (e.g., a phase noise tolerance) associated with transmitting and receiving the communications signal may become more strict—e.g., small increases in phase noise may result in increased bit errors.

One option for increasing a noise performance of a communication system is to use DROs to generate a local oscillator signal for communication circuitry—e.g., DROs may exhibit improved phase noise relative to IC oscillators, such as ring oscillators or resonant circuits. However, a cost of DROs may be significantly higher relative to IC oscillators. Also, DROs can be microphonic. Additionally, DROs may be packaged as a dielectric puck that is adhered to an antenna and, in some examples, can experience adhesion failures that require physical maintenance.

To improve a noise performance of a communication system without using DROs, multiple IC oscillators may be used together to generate a single local oscillator signal for communication circuitry. By combining the local oscillator signals of the multiple IC oscillators, a single local oscillator signal with improved phase noise may be generated—e.g., because the main component of the local oscillator signals generated by the IC oscillators may coherently combine while the phase noise component of the local oscillator signal may noncoherently combine. However, to maintain the improved phase noise characteristics for a multi-IC oscillator circuit (which may also be referred to as a multi-IC local oscillator circuit), calibration procedures to maintain the phase alignment of the IC oscillators may be performed (e.g., periodically, at least once in a set duration, etc.).

One option for phase calibration may include rotating the phase of one IC oscillator relative to another IC oscillator and comparing the signals until the phase is aligned (e.g., using signal magnitude). However, communications may be impaired while the calibration procedure is performed (e.g., due to the increased phase noise generated during the calibration procedure). Another option for phase calibration may include computing the phases of different IC oscillators and changing the determined phases of one or more of the individual IC oscillators so that the phases of the IC oscillators become aligned. Since phase measurements may be performed relative to a reference phase, aligning the phase of the IC oscillators may include individually turning on each of the IC oscillators and comparing a phase of the enabled oscillator to a reference phase. Because a portion of the oscillators may be turned off during alignment, there may be a degradation in the performance of the multi-IC oscillator. Thus, this option may be associated with an increased cost and complexity relative to performing a phase rotation search using amplitude.

To enable the efficient calibration of multi-IC oscillators while reducing disruption to communications, the calibration procedure may be performed during periods in which phase noise tolerance for a communications system, multi-IC oscillator, or both, are relaxed—e.g., when communications signals are not being received, when the multi-IC oscillator is not being used, during periods of reduced demand, when a lower-order modulation is configured, etc.

In some examples, a device (e.g., the user terminal 115, the first access node 105-1, the second LEO satellite 110-2, or the GEO satellite 120) includes one or more multi-IC oscillators, where a multi-IC oscillator may be configured to generate a local oscillator signal used by the device to support communications (e.g., to generate a carrier signal, to downconvert a carrier signal, to identify symbol boundaries, etc.) via the access network. As described herein, the phase noise of the multi-IC oscillator may increase over time—e.g., as the phases of the IC oscillators in the multi-IC oscillator drift out of alignment with one another. Accordingly, a calibration procedure may be configured to return the phase noise characteristic of the multi-IC oscillator to a desired operating range. The device may be further configured to determine a time period for calibrating the multi-IC oscillator, where the time period may be selected to reduce an impact of the calibration procedure on the communications performed by the device. For example, the device may determine a time period that is associated with relaxed noise tolerance for local oscillator signals—e.g., a time period during which noise tolerance is increased. For example, the device may determine a time period when phase noise tolerance is relaxed for a local oscillator signal—e.g., when lower order communications are performed, when no communications are being performed by the device (e.g., during a handover procedure or prepass procedure), and the like.

As discussed herein, the coverage areas of individual satellites change over time and a communication stream may be handed over from one satellite to another. As part of handing over the communication stream, an antenna of the device (or of a different device) may be repositioned from being oriented toward one satellite to being oriented toward a different satellite. In some examples, while being repositioned to be oriented toward the different satellite, the device may not perform communications. Thus, the device may determine a time period for reorienting an antenna (e.g., a retrace period or prepass period) as being associated with relaxed noise tolerance for a local oscillator signal (e.g., as no communications are being performed using the local oscillator signal).

In some examples, the device may configure a lower-order modulation—e.g., during periods of reduced demand, if a calibration procedure for the multi-IC oscillator hasn't been performed within a duration, etc. In such cases, phase noise tolerance for communications using the lower-order modulation may be relaxed (e.g., communications may be received with an acceptable error rate while increased phase noise is present). Thus, the device may identify a time period when a lower-order modulation is configured as being associated with relaxed noise tolerance. In such cases, the device may continue to perform communications at a same time as calibrating the multi-IC oscillator.

In some examples, the device may include multiple multi-IC oscillators. The device may be configured to switch between the multiple multi-IC oscillators—e.g., based on a rate of change in phase noise characteristics of the multi-IC oscillator, etc. Thus, the device may determine, for a multi-IC oscillator, that a time period when the multi-IC oscillator is not in use as being associated with relaxed noise tolerance for a local oscillator signal—e.g., as the multi-IC oscillator is not currently being used to support communications. In such cases, the device may calibrate the multi-IC oscillator that is not in use while performing communications using the other multi-IC oscillator.

By identifying time periods when phase noise tolerances are (or will be) relaxed for local oscillator signals, opportunities for calibrating a multi-IC oscillator with reduced disruption to communications may be identified. Additionally, or alternatively, by identifying time periods when phase noise tolerances are (or will be) relaxed for local oscillator signals, opportunities for calibrating a multi-IC oscillator may be created—e.g., if the multi-IC oscillator has not been calibrated for a duration. Some examples for creating such opportunities include temporarily configuring a lower-order modulation technique for communications, swapping out a multi-IC oscillator with another multi-IC oscillator, and the like.

In some examples, a period during which phase noise tolerances for local oscillator signals are relaxed may not occur within a threshold time period for calibrating a multi-IC oscillator. In such cases, techniques for calibrating a local oscillator signal while communications having tighter phase noise tolerances are performed may be desired. In such cases, respective subsets of the multi-IC oscillator may be calibrated during periods when phase-noise sensitive communications are ongoing, where minor adjustments to one or more of the multi-IC oscillators may be performed while communications are ongoing. A partially aligned oscillator may use small phase change to find the maximum. In the region of partial alignment, there may only be a slight degradation as the phase is aligned and the system may operate without an increase in bit error.

Although described in the context of a satellite communication system, the techniques described herein may similarly be applied in other communication systems (e.g., a terrestrial communication system).

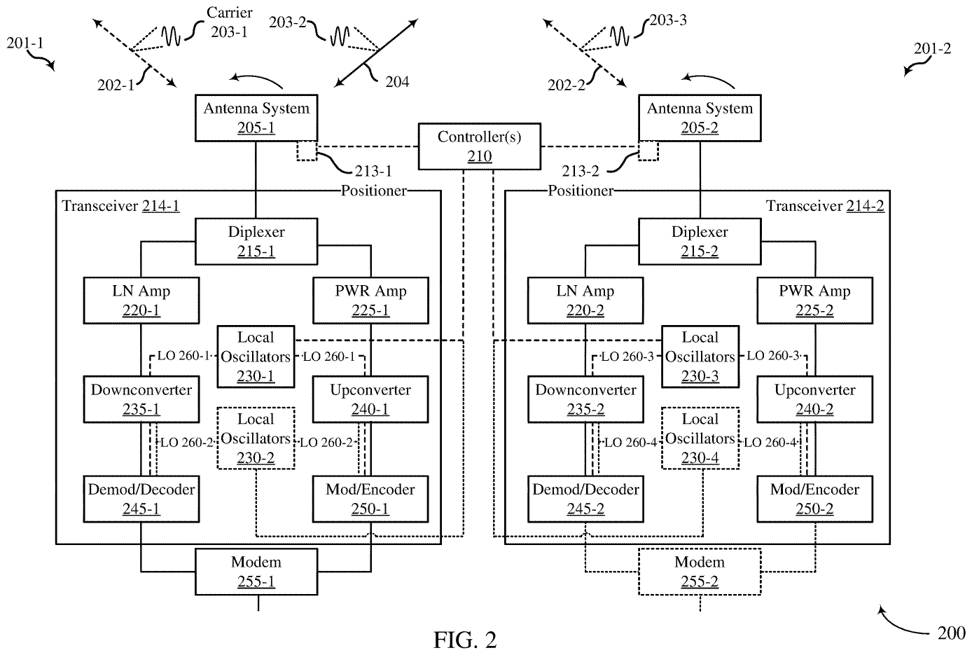

FIG. 2 shows an example of a subsystem that supports oscillator phase noise calibration in accordance with examples as disclosed herein.

The subsystem 200 depicts multiple communication subsystems (including the first communication subsystem 201-1 and the second communication subsystem 201-2) for receiving and processing communication signals. In some examples, the subsystem 200 includes only one of the communication subsystems 201 (e.g., the first communication subsystem 201-1), where the one of the communication subsystems 201 may have one or more antennas. In some examples, the communication subsystems 201 may share one or more components with one another (e.g., communication subsystems 201 may share a modem). The communication subsystems may be implemented in an access node (such as the access nodes described with reference to FIG. 1), a user terminal (such as the user terminals described with reference to FIG. 1), or a satellite (such as the LEO satellites or the GEO satellites described with reference to FIG. 1).

The first communication subsystem 201-1 may include the first antenna system 205-1, the first positioner 213-1, the first transceiver 214-1, and the first modem 255-1. The first antenna system 205-1 may be used to detect and emit communication signals. The first positioner 213-1 may be configured to orient the antenna in a direction—e.g., a direction of an incoming communication signal. Additionally, or alternatively, digital beamforming techniques may be used to orient signal transmission and reception at the first antenna system 205-1 without physically altering a position of the antenna.

The first transceiver 214-1 may be configured to receive and transmit communication signals. The first transceiver 214-1 may include the first diplexer 215-1, the first low noise amplifier 220-1, the first power amplifier 225-1, the first local oscillators 230-1, the first downconverter 235-1, the first upconverter 240-1, the first demodulator/decoder 245-1, and the first modulator/encoder 250-1. The first transceiver 214-1 may also include the second local oscillators 230-2.

The first diplexer 215-1 may be used to process incoming and outgoing communications signals. For example, the first diplexer 215-1 may be used to combine and divide transmit and receive signals (e.g., according to different frequency bands). The first low noise amplifier 220-1 may be used to amplify received communications signals. The first power amplifier 225-1 may be used to amplify the communication signals to be transmitted. The first downconverter 235-1 may be configured to downconvert a received radio frequency (RF) signal (e.g., the first RF signal 203-1) carrying the communication signals from a carrier frequency to a lower frequency (e.g., an intermediate frequency (IF), a baseband). The first upconverter 240-1 may be used to multiplex (e.g., mix) a carrier frequency with the communication signals to be transmitted (e.g., to create second RF signal 203-2).

The first demodulator/decoder 245-1 may be configured to extract bit-level data from the received communications signals. As part of extracting the bit-level data, the first demodulator/decoder 245-1 may demodulate the received communication signals. That is, the first demodulator/decoder 245-1 may identify which symbol points in a symbol constellation different portions (e.g., symbols) of the received communications signals correspond. Identifying the symbol points may include identifying a magnitude and phase of the different portions of the received communications signals. To construct the bit-level data, the first demodulator/decoder 245-1 may determine one or more bits associated with the symbols identified for the different portions. The first demodulator/decoder 245-1 may decode the one or more bits to obtain the application-level data—e.g., by applying a linear block code to the one or more bits.

The first modulator/encoder 250-1 may be configured to convert bit-level data into communications symbols to be included in a communication signal. The first modulator/encoder 250-1 may encode (e.g., by applying a linear block code to the one or more bits) application data to obtain encoded data bits (which may be referred to as codewords). The first modulator/encoder 250-1 may further map the encoded data bits to symbol points in a symbol constellation. As part of converting the encoded bits into communication symbols, the first modulator/encoder 250-1 may modulate one or more bits of the bit-level data based on the symbol points in a symbol constellation. That is, the first modulator/encoder 250-1 may map the one or more bits to symbol points and may generate the communication symbols accordingly. Generating the communication symbols may include generating a signal with a magnitude and phase that corresponds to a respective communication symbol. In some examples, a set of the communication symbols generated by the first modulator/encoder 250-1 may be included in a communication signal to be transmitted.

The first modem 255-1 may be configured to process the received bit-level data from the first demodulator/decoder 245-1 and to send bit-level data to the first modulator/encoder 250-1. In some examples, the first modem 255-1 may identify data packets in the received bit-level data. The first modem 255-1 may forward the identified data packets to one or more respective devices (e.g., via a router, network device, etc.). The first modem 255-1 may also package the bit-level data into data packets to be transmitted and send the data packets to the first modulator/encoder 250-1. In some examples, the first modem 255-1 may support the delivery of a communication stream to a user terminal, where a communication stream may include data exchanged between the user terminal and another device for a particular transaction (e.g., streaming of a video, downloading of photos, an IP call, etc.).

The first local oscillators 230-1 may be configured to generate the first local oscillator signal 260-1 having noise characteristics that are below a noise threshold—e.g., first local oscillator signal 260-1 may exhibit less phase noise than a phase noise threshold. The first local oscillators 230-1 may include multiple local oscillators that each generate a respective local oscillator signal. The first local oscillators 230-1 may each be implemented using integrated circuitry—e.g., a ring oscillator, a resonator circuit, etc. In some examples, an individual oscillator of the first local oscillators 230-1 may output a local oscillator signal that has phase noise characteristics that exceed a phase noise threshold—e.g., that may be 3 dB higher than the phase noise threshold.

The local oscillator signals generated by the first local oscillators 230-1 may be combined to generate a single local oscillator signal (the first local oscillator signal 260-1). Because the signal components in the main band of the local oscillator signals may be coherent while the signal components in the side bands of the local oscillator signal (e.g., the noise components) may be noncoherent, combining the local oscillator signals may result in a larger signal gain in the main band than in the sidebands. For example, the signal power of the coherent components may increase at a 20 log N rate while the non-coherent components may increase at a 10 log N rate, where N may be the number of non-coherent components that are combined. For example, when combining N oscillator signals together, the signal power may add together as 20 log N and the noise power may add together as 10 log N. Thus, combining four (4) oscillators together may result in a phase improvement equal to 20 log 4−10 log 4≈6 dB. In some examples, the signal-to-noise power improvement may be obtained if the phase noise of the oscillator is larger than the multiplied reference phase noise by greater than ten (10) dBs. Techniques for combining the respective local oscillator signals may include adding the respective local oscillator signals together, mixing the local oscillator signals together, or multiplying the local oscillator signals.

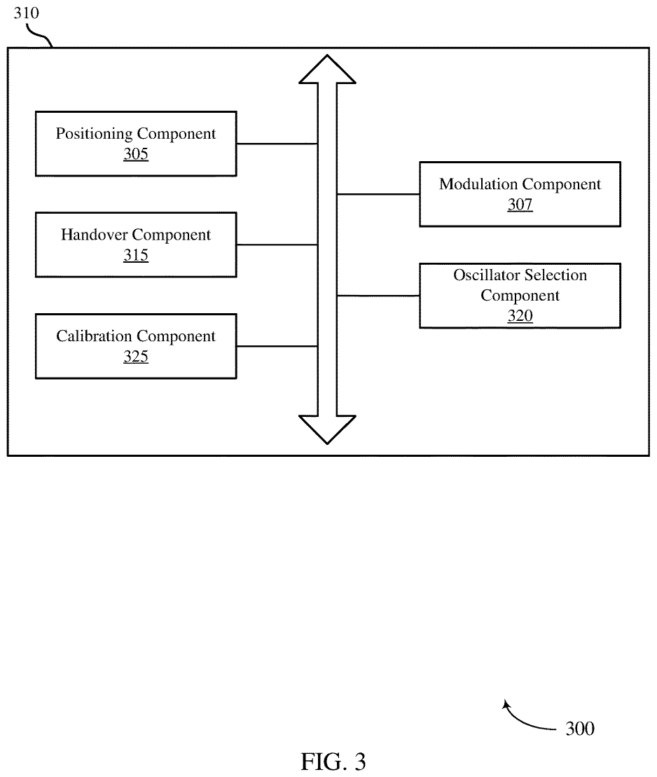

To achieve the improved signal-to-noise ratio, the phases of the local oscillator signals may need to be aligned. Accordingly, as the phases of the local oscillator signals drift out of alignment, the phase noise of the combined local oscillator signal (the first local oscillator signal 260-1) may also increase. In some examples, phase alignment may contribute dB for dB to phase noise degradation—e.g., because the phase noise power level (dBm/Hz) may remain constant in power while the signal power degrades with misalignment. Thus, the first local oscillators 230-1 may be calibrated (e.g., periodically, once within a repeating interval, etc.) to maintain the phase alignment, as described herein including with reference to FIGS. 3-6.

The first local oscillators 230-1 may provide the first local oscillator signal 260-1 to other components in the first communication subsystem 210-1. For example, the first local oscillator signal 260-1 may be used by the first downconverter 235-1 as a mixing signal for downconverting a received communication signal. The first local oscillator signal 260-1 may be used by the first demodulator/decoder 245-1 to generate a frequency signal for identifying the boundaries of communication symbols. The first local oscillator signal 260-1 may be used by the first upconverter 240-1 to for upconverting a communication signal. The first local oscillator signal 260-1 may be used by the first modulator/encoder 250-1 to generate a frequency signal for setting the boundaries of communication symbols.

The second local oscillators 230-2 may similarly be configured to generate the second local oscillator signal 260-2. In some examples, the second local oscillators 230-2 may be configured to operate as a backup set of local oscillators for the subsystem 200. In some examples, the second local oscillators 230-2 may be calibrated to maintain phase alignment with the first local oscillators 230-1—e.g., so that the first local oscillator signal 260-1 may be replaced with the second local oscillator signal 260-2 with reduced (e.g., no) phase disruption.

The controller 210 may be configured to control aspects of the first communication subsystem 201-1. The controller 210 may also be configured to control aspects of the second communication subsystem 201-2. In some examples, the controller 210 may include multiple controllers—e.g., a first controller to control aspects of the first communication subsystem 201-1 and a second controller to control aspects of the second communication subsystem 201-2.

The controller 210 may be configured to calibrate the local oscillators. In some examples, the controller 210 is configured to calibrate the local oscillators 230 at least once within a time interval. Additionally, or alternatively, the controller 210 may be configured to calibrate the local oscillators 230 based on a phase noise tolerance for a communication subsystem. In some examples, the controller 210 may be configured to calibrate the local oscillators 230 when a tolerance for phase noise in a local oscillator signal reaches a phase noise threshold—e.g., when a local oscillator signal can include a threshold amount of phase noise, such as 2% phase noise or 1 dB of phase noise, and communications can still be received with a threshold bit error rate. For example, the controller 210 may be configured to calibrate the first local oscillators 230-1 when the first communication subsystem 201-1 is not receiving or transmitting data—e.g., during a retrace period of a handover procedure from the LEO link 204 to the first handover link 202-1, a prepass period, a standby period, etc. In another example, the controller 210 may be configured to calibrate the first local oscillators 230-1 when the first communication subsystem 201-1 is communicating data using a lower-order modulation order—e.g., during a reduced-demand period, a calibration period, etc.

Additionally, or alternatively, the controller 210 may be configured to calibrate the local oscillators 230 based on whether the local oscillators 230 are in use by a communication subsystem. For example, the controller 210 may be configured to calibrate the second local oscillators 230-2 when the first local oscillators 230-1 are being used to generate the local oscillator signal for the first communication subsystem 201-1, and vice versa. The controller 210 may further be configured to control which of the first local oscillators 230-1 or the second local oscillators 230-2 is being used to generate the local oscillator signal for the first communication subsystem 201-1—e.g., based on a calibration duration, a current temperature, etc. In some examples, the controller 210 may calibrate a set of local oscillators based on determining that a communication subsystem is configured to switch to the set of local oscillators within a duration.

The second communication subsystem 201-2 may be configured similarly as the first communication subsystem 201-1. In some examples, the second communication subsystem 201-2 may share one or more components with the first communication subsystem 201-1, such as the first modem 255-1. In some examples, a communication stream for a user terminal may be switched from the first communication subsystem 201-1 to the second communication subsystem 201-2. For example, during a handover procedure that involves orienting (e.g., physically or digitally) the second antenna system 205-2 toward an incoming LEO satellite while the first antenna system 205-1 is tracking an outgoing LEO satellite and connected to the outgoing LEO satellite via the LEO link 204. In some examples, the controller 210 may be configured to calibrate the third local oscillators 230-3, the fourth local oscillators 230-4, or both, based on determining that the second antenna system 205-2 is being oriented toward the incoming LEO satellite to establish the second handover link 202-2. The controller 210 may also be configured to calibrate the first antenna system 205-1 once a connection with the outgoing LEO satellite is lost.

FIG. 3 shows an example of a controller that supports oscillator phase noise calibration in accordance with examples as disclosed herein.

The controller 310 may be configured to control the operations of one or more communication subsystem, including handover operations, calibration operations, oscillator switching operations, communication mode selection, positioning operations, and the like. The controller 310 may be, or be an example of, the controller described with reference to FIG. 2. The controller 310 may include the positioning component 305, the modulation component 307, the handover component 315, the oscillator selection component 320, and the calibration component 325.

The positioning component 305 may be configured to orient a radiation path of an antenna (e.g., first antenna system 205-1 or second antenna system 205-2 of FIG. 2) in a particular direction—e.g., to track a movement of a satellite overhead. In some examples, the positioning component 305 may be configured to drive a positioner that physically changes an orientation of the antenna so that the radiation path of the antenna is pointed in a desired direction. Additionally, or alternatively, the positioning component may be configured to digitally change the radiation path of the antenna so that the radiation path of the antenna points in a desired direction.

The modulation component 307 may be configured to control a modulation order used by a modulation and coding component (e.g., the first demodulator/decoder 245-1, the second demodulator/decoder 245-2, the first modulator/encoder 250-1, or the second modulator/encoder 250-2 of FIG. 2). In some examples, them modulation component directs one or more modulation and coding components to use a first modulation order for a first duration and a second modulation order for a second duration.

The handover component 315 may be configured to coordinate the handover of a communication stream for a user terminal from one satellite to another satellite, from one antenna to another antenna, or a combination thereof. In some examples, the handover component 315 is configured to track a trajectory of a first satellite that is overhead and to identify a trajectory of an incoming satellite as a connection with the first satellite is being lost.

The oscillator selection component 320 may be configured to switch between multiple multi-IC oscillators implemented with a communication subsystem. In some examples, the oscillator selection component 320 is configured to switch between the multi-IC oscillators based on temperature parameters. In some examples, the oscillator selection component 320 is configured switch between the multi-IC oscillators based on a change in phase noise characteristics of the multi-IC oscillators over time.

The calibration component 325 may be configured to calibrate one or more multi-IC oscillators to maintain (and, in some examples, return) a phase noise of the one or more multi-IC oscillators below a threshold. Calibrating the one or more multi-IC oscillators may include aligning a phase of each of the local oscillator signals generated by the oscillators of a multi-IC oscillator. In some examples, aligning the phase of the local oscillator signals may include rotating the phase of one or more of the local oscillator signals until a peak (or, in some examples, a null) in the one or more local oscillator signals is aligned with the peak (or, in some examples, the null) in the other local oscillator signal (e.g., a reference local oscillator signal). Adjusting the phase of the local oscillators may be achieved by running the local oscillators in a fractional mode and changing the value of a mash seed to obtain a desired phase shift; or by using phase shifters at the inputs or outputs of the local oscillators.

For the case of partial alignment, aligning the phase of the local oscillator signals may include using an I/Q component to determine a phase of the oscillators and changing (e.g., adding or subtracting) a phase of the local oscillator signals such that the phase of the local oscillator signals is aligned. In some examples, aligning the phase of the local oscillator signals may include perturbing the phase of one or more of the local oscillator signals in both directions to first identify a direction of phase misalignment.

In some examples, the calibration component 325 may be configured to calibrate the one or more multi-IC oscillators based on an activity of the other components in the controller 310. For example, the calibration component 325 may be configured to calibrate a multi-IC oscillator in a communication subsystem based on determining that the positioning component 305 is reorienting the antenna of the communication subsystem. Additionally, or alternatively, the calibration component 325 may be configured to calibrate a multi-IC oscillator in a communication subsystem based on determining that the modulation component 307 has directed a decoder and/or encoder in the communication subsystem to use a lower-order modulation (e.g., less than 64-QAM). Additionally, or alternatively, the calibration component 325 may be configured to calibrate a multi-IC oscillator in a communication subsystem (e.g., the second communication subsystem 201-2 of FIG. 2) based on determining that the handover component 315 has selected the communication subsystem to take over a communication stream from another communication subsystem (e.g., the first communication subsystem 201-1 of FIG. 2). Additionally, or alternatively, the calibration component 325 may be configured to calibrate a first multi-IC oscillator in a communication subsystem based on determining that the oscillator selection component 320 has selected the second multi-IC oscillator (e.g., the second local oscillators 230-2 of FIG. 2) to provide the local oscillator signal instead of the first multi-IC oscillator (e.g., the first local oscillators 230-1 of FIG. 2).

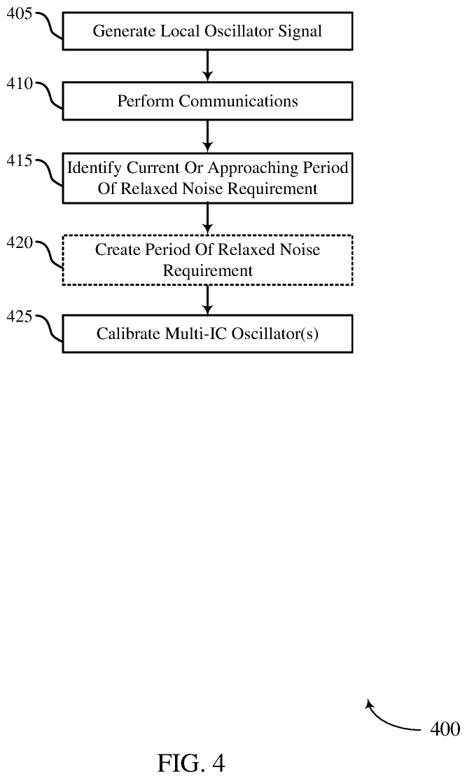

FIG. 4 shows an example of a set of operations for oscillator phase noise calibration in accordance with examples as disclosed herein.

The flowchart 400 may be performed by one or more communication subsystems, such as the communication subsystems described with reference to FIG. 2. In some examples, a communication subsystem may include one antenna system (e.g., an antenna array, a dish, etc.) and one or more multi-IC oscillators. In some examples, the flowchart 400 shows an example set of operations performed to support oscillator phase noise calibration. For example, the flowchart 400 may include operations for calibrating one or more multi-IC oscillator during a period of time in which phase noise tolerances for the one or more multi-IC oscillator are increased.

Aspects of the flowchart 400 may be implemented by a controller, among other components. Additionally, or alternatively, aspects of the flowchart 400 may be implemented as instructions stored in memory (e.g., firmware stored in a memory coupled with a controller). For example, the instructions, when executed by a controller, may cause the controller to perform the operations of the flowchart 400.

One or more of the operations described in the flowchart 400 may be performed earlier or later, omitted, replaced, supplemented, or combined with another operation. Also, additional operations described herein may replace, supplement or be combined with one or more of the operations described in the flowchart 400.

At 405, a combined local oscillator signal may be generated (e.g., by a multi-IC oscillator, such as the first local oscillators 230-1, the second local oscillators 230-2, the third local oscillators 230-3, or the fourth local oscillators 230-4 of FIG. 2). The combined local oscillator signal may be used by a communication subsystem to support communications—e.g., by upconverting a communication signal, downconverting a communication signal, generating a timing signal for identifying symbol boundaries, etc. The combined local oscillator signal may be generated to have a phase noise that is below a phase noise threshold—e.g., to support higher frequencies, higher data rates, or both. To achieve the desired phase noise, the combined local oscillator signal may be generated by combining local oscillator signals generated by one or more oscillators of the multi-IC oscillator to obtain the combined local oscillator signal having desired phase noise characteristics. Combining the local oscillator signals may include adding the local oscillator signals together, mixing the local oscillator signals together, multiplying the local oscillator signals, or a combination thereof.

At 410, communications may be performed by the communication subsystem—e.g., using the combined local oscillator signal. In some examples, the communication subsystem supports the communication of multiple communication streams for multiple user terminals. A communication stream may be associated with a communication or data transaction between a user terminal and another device. For example, the data transaction may be associated with the user terminal downloading or streaming information from a server on a data network (such as the Internet).

In some examples, the communication stream may be communicated between a first set of devices (e.g., a first access node, a first satellite, a user terminal) during a first time period. For LEO-based and MEO-based communications, a coverage area of a first satellite changes and a direct connection between a first access node and the first satellite may be lost as the first satellite travels along its trajectory. Accordingly, the communication stream may be communicated through a second set of devices (e.g., the first access node, a second satellite, and the user terminal; or a second access node, a second satellite, and the user terminal) during a subsequent time period. As described herein, the procedure for switching the communication of the communication stream from one set of devices to another set of devices may be referred to as a handover procedure.

For GEO-based communications, a coverage area of the first satellite may remain constant. Accordingly, the communication stream may be communicated between a same set of devices for an extended duration—e.g., days, weeks. To support GEO-based communications, the first access node may be configured with a first multi-IC oscillator and a second, backup multi-IC oscillator.

As described herein, phase noise characteristics of multi-IC oscillators may degrade over time, and without calibration of the multi-IC oscillators, a bit error rate for communications may increase. Accordingly, a controller (e.g., the controller 210 of FIG. 2) may monitor for and/or create opportunities for calibrating the multi-IC oscillator.

At 415, a current or approaching time period during which noise tolerance is or will be relaxed for a multi-IC oscillator may be identified (e.g., by the controller). Put another way, a current or approaching time period during which a tolerance for phase noise in the combined local oscillator signal reaches a threshold—e.g., a communication can be received with greater than a threshold amount of phase noise (e.g., greater than two percent phase noise) in the combined local oscillator signal—may be identified. In some examples, the controller may identify that a radiation path of an antenna of the communication subsystem is being (or will be) reoriented as part of handing a communication stream over from an outgoing LEO satellite to an incoming LEO satellite. The controller may thus identify the time period during which the antenna is (or will be) reoriented as a time period during which the phase noise tolerance for the one or more multi-IC oscillators is (or will be) above a phase noise threshold—e.g., as communications may be stopped.

In some examples, the controller may identify that a reduced-order modulation is being (or will be) used by the communication subsystem for communications—e.g., during a period of reduced communication demand, for communication of certain types of data. The controller may thus identify the time period during which the reduced-order modulation is (or will be) used as a time period during which the phase noise tolerance for the one or more multi-IC oscillators is (or will be) above the phase noise threshold.

In some examples, the controller may identify that a multi-IC oscillator is (or will be) swapped out with another multi-IC oscillator by the communication subsystem—e.g., according to a switching schedule, based on an ambient temperature. The controller may thus identify the time period during which the multi-IC oscillator is (or will be) swapped as a time period during which the phase noise tolerance for the swapped out multi-IC oscillator is (or will be) above the phase noise threshold—e.g., as the multi-IC oscillator may not be used to support communications while it is swapped out.

In some examples, the controller may identify that a communication stream will be handed over from the communication subsystem to a second communications subsystem. The controller may thus identify the time period prior to handing over the communications to the second communications system (e.g., before and/or while an antenna of the second communications system is reoriented) as a time period during which the phase noise tolerance for multi-IC oscillators at the second communications subsystem is (or will be) above a phase noise threshold—e.g., as the second communications system may not yet be performing communications. The controller may also identify the time period after communications are handed over to the second communications system as a time period during which the phase noise tolerance for multi-IC oscillators at the initial communications subsystem is (or will be) above a phase noise threshold—e.g., as the second communications system may not yet have established a new connection. Additionally, or alternatively, the time period may be identified as a time period during which the tolerance for phase noise in the one or more multi-IC oscillators reaches a threshold—a time period during which a predetermined) amount of phase noise (which may be introduced in part by the calibration procedure) is acceptable.

At 420, if a current or approaching relaxed noise period has not been identified within a duration, the controller may create a relaxed noise period for one or more of the multi-IC oscillators. For example, the controller may configure the communications subsystem to use a reduced-order modulation for a time period. In some examples, the controller may swap out a multi-IC oscillator to create a relaxed noise period for the multi-IC oscillator.

At 425, one or more multi-IC local oscillator at the communications subsystem may be calibrated during the relaxed noise period—e.g., identified or created by the controller. If the communications subsystem includes a single multi-IC oscillator, then the single multi-IC oscillator may be calibrated during the relaxed noise period. In some examples, if the relaxed noise period corresponds to a period during which a reduced-order modulation is used, the communication subsystem may continue to perform communications while the multi-IC oscillator is being calibrated.

If the communications subsystem includes multiple multi-IC oscillators, then one or more of the multi-IC oscillators may be calibrated during the relaxed noise period. For example, if the relaxed noise period corresponds to a period during which a reduced-order modulation is used, then all of the multi-IC oscillators may be calibrated during the relaxed noise period. In another example, if the relaxed noise period corresponds to a period during which one or more of the multi-IC oscillators is not in use, then the relaxed noise period may be identified only for the multi-IC oscillator(s) that are not in use and only the multi-IC oscillator(s) that are not in use may be calibrated during the relaxed noise period.

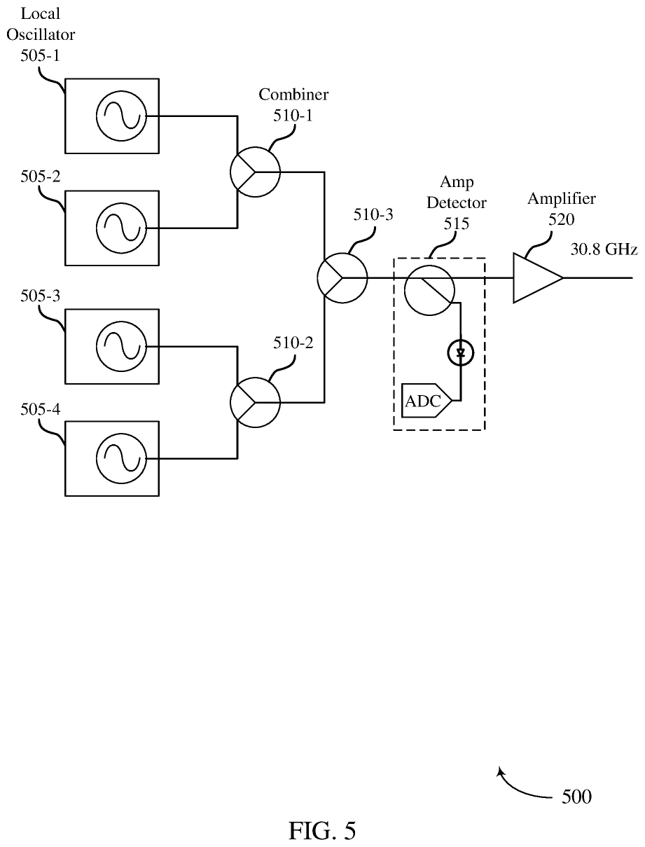

In some examples, to calibrate a multi-IC oscillator, a phase of one reference IC oscillator in the multi-IC oscillator may be maintained while a phase of one or more other IC oscillators in the multi-IC oscillators may be rotated. Based on rotating the phase of the other IC oscillators, a magnitude (e.g., a peak or null) of the local oscillator signals generated by the other IC oscillators may be compared with the magnitude (e.g., a peak or null) of the local oscillator signal of the reference IC oscillator. When the peak (or null) of one IC oscillator of the other IC oscillators is aligned with the peak (or null) of the reference IC oscillator, the one IC oscillator may be aligned with the reference IC oscillator. Calibrating a multi-IC oscillator based on magnitude information is described in more detail herein, including with reference to FIG. 5.

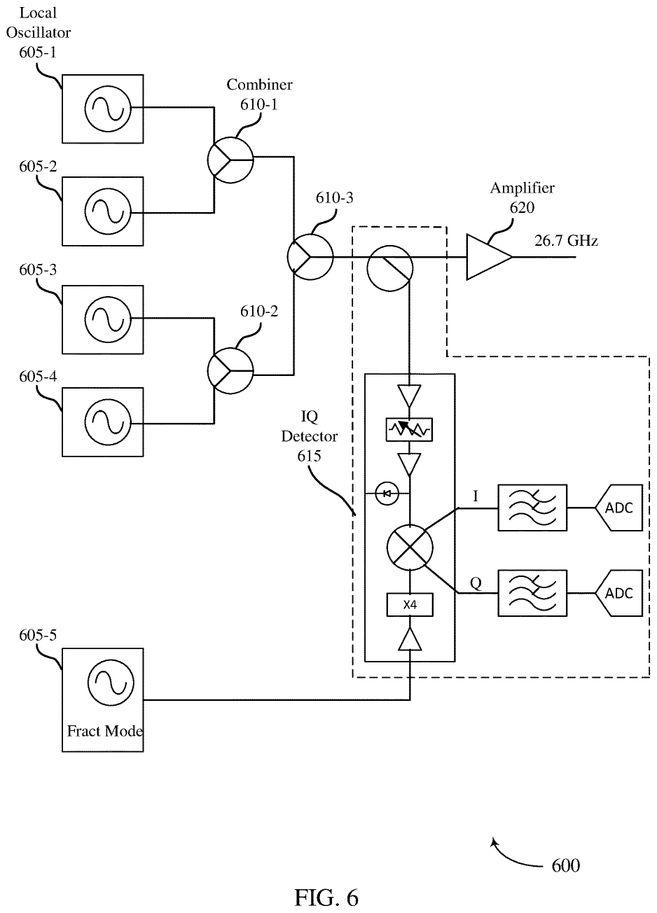

In some examples, to calibrate a multi-IC oscillator, a phase of the IC oscillators in the multi-IC oscillator may be calculated—e.g., using an I/Q component. Based on determining the phase of the IC oscillators, corresponding phase shifts may be applied to the IC oscillators such that the current phase of the IC oscillators will be aligned. Calibrating a multi-IC oscillator based on I/Q information is described in more detail herein, including with reference to FIG. 6.

In some examples, a duration of the identified relaxed noise period is not long enough to support the full calibration of a multi-IC oscillator. In such cases, a first type of round-robin calibration may be performed where a first subset of the IC oscillators in the multi-IC oscillator are aligned during a first relaxed noise period, a second subset of the IC oscillators in the multi-IC oscillator are aligned during a second relaxed noise period, and so on.

In some examples, a relaxed noise period may not be identified or created within a predetermined period for calibrating multi-IC oscillators, where the predetermined period may be associated with a minimum period for using a multi-IC oscillator without calibration before the phase noise in a combined local oscillator signal generated by the multi-IC oscillator exceeds a threshold phase noise. In such cases, a second type of round-robin calibration may be performed which may involve calibrating multi-IC oscillators outside of a relaxed phase noise duration. When oscillators are partially aligned, the phase variation for full alignment may represent a small phase change. This small misalignment may result in a tolerable degradation of the combined local oscillator signal—e.g. a degradation that does not result in an increase in bit error rate. To calibrate the multi-IC oscillator while phase noise tolerances are not relaxed, small phase adjustments (e.g., smaller than a nominal calibration procedure) may be applied to subsets (e.g., one or more) of the local oscillators while communications are ongoing. In some examples, as part of applying the phase adjustments, a phase of the subsets of the local oscillators may be adjusted in a first direction and a second direction to identify a direction of phase misalignment between a subset of the local oscillators and a reference local oscillator. The phase may be adjusted to identify when the oscillator under control is aligned to the average of the other oscillators. This may be achieved when the combined oscillators are at an amplitude maximum.

In some examples, the second type of round-robin calibration may be available only when the local oscillators of a multi-IC oscillator are each within a threshold alignment with one another—e.g., after an initial calibration is performed for a multi-IC oscillator. In some examples, the calibrations performed for the second type of round-robin calibration may be performed during relaxed noise periods, strict noise periods, or both. In some examples, the calibrations performed for the second type of round-robin calibration may be performed during strict noise periods and more aggressive calibrations (e.g., calibrations performed for the first type of round-robin calibrations) may be performed during relaxed noise periods.

FIG. 5 shows an example of a multi-IC local oscillator circuit that supports oscillator phase noise calibration in accordance with examples as disclosed herein.

The multi-IC local oscillator 500 may include local oscillators (including first local oscillator 505-1 through fourth local oscillator 505-4), combiners (including first combiner 510-1 through third combiner 510-3) for combining the local oscillator signals generated by the local oscillators to obtain a single combined local oscillator signal, the amplitude detector 515 for supporting calibration of the multi-IC local oscillator 500, and the amplifier 520. In some examples, the multi-IC local oscillator 500 may be an example of one of the local oscillators 230 of FIG. 2.

To align the phase of the local oscillators 505, the amplitude detector 515 may determine when a maximum signal is output by the multi-IC local oscillator 500 as the phase of the local oscillators are rotated. When the maximum signal is output, it may be determined that the local oscillators 505 are aligned in-phase. In some examples, a significant amplitude change occurs when the phase of a local oscillator is misaligned by around 10 to 20 degrees. Additionally, or alternatively, the amplitude detector 515 may determine when a minimum signal is output by the multi-IC local oscillator 500 as the phase of the local oscillators are rotated. When the minimum signal is output, it may be determined that the local oscillators 505 are misaligned in-phase by 180 degrees and a 180 degree phase shift may be added to reach a maximum for the combined oscillators. In some examples, identifying the maximum signal may be associated with reduced degradation of the combined local oscillator signal relative to identifying the minimum signal.

The multi-IC local oscillator 500 may be calibrated using a full calibration or a round-robin calibration. In some examples, the full calibration may result in the most accurate alignment and may be used for an initial alignment. The round-robin calibration may be faster than the full calibration but may assume some measure of alignment prior to using. The round-robin calibration may be used to maintain alignment—e.g., after a full alignment is performed.

In a first option for performing a full calibration, one local oscillator (e.g., the first local oscillator 505-1) may be used as a reference and may generate a reference local oscillator signal. Subsequent, the other local oscillators may be turned on individually (e.g., one at a time) and adjusted in phase to align with the reference local oscillator signal to achieve a maximum amplitude for the resulting combined local oscillator signal (or, alternatively, to obtain a minimum amplitude followed by a 180 degree phase adjustment). After achieving alignment of each of the local oscillators, all of the local oscillators may be enabled to generate a single combined local oscillator signal.

In a second option for performing a full calibration, all of the local oscillators 505 may be left on, and the phase of one local oscillator at a time may be adjusted to identify a combined maximum amplitude for the combined local oscillator signal (or, alternatively, to obtain a minimum amplitude followed by a 180 degree phase adjustment for three of the local oscillators 505). After rotating the phase of all of the local oscillators 505 in this way, the phase of the local oscillators 505 may be aligned. In some examples, a decrease in the amplitude of the single combined local oscillator signal may be compared against a threshold amplitude to trigger a full calibration. In some examples, the full calibration may be performed when the phase noise tolerance for the multi-IC local oscillator 500 is above a threshold (e.g., during a retrace time, while a lower-order modulation technique is used, etc.).

A round-robin calibration may be used to perform a partial alignment to correct slight misalignments that occur over time—e.g., after a full calibration. A partial alignment may involve less rotation of phase to achieve a full alignment and may be performed when the amplitude of the combined local oscillator signal is near a maximum value. For example, a round-robin calibration may be performed when the phase of a local oscillator is within 20 degrees of the other local oscillators. In some examples, the round-robin calibration may be performed when the phase noise tolerance for the multi-IC local oscillator 500 is below a threshold (e.g., while communications are ongoing using a higher modulation order).

The amplitude detector 515 may be positioned before the amplifier 520 to minimize component temperature variations that occur before the amplitude detector 515, which may be incorrectly identified as a change in amplitude caused by phase noise misalignment.

FIG. 6 shows an example of a multi-IC local oscillator circuit that supports oscillator phase noise calibration in accordance with examples as disclosed herein.

The multi-IC local oscillator 600 may include local oscillators (including first local oscillator 605-1 through fifth local oscillator 605-5), combiners (including first combiner 610-1 through third combiner 610-3) for combining the local oscillator signals generated by the local oscillators to obtain a single combined local oscillator signal, the IQ detector 615 for supporting calibration of the multi-IC local oscillator 600, and the amplifier 620. In some examples, the multi-IC local oscillator 600 may be an example of one of the local oscillators 230 of FIG. 2.

To align the phase of the local oscillators 605, the IQ detector 615 may be configured to determine a phase of each of the local oscillators 605. In some examples, to determine the phase of each of the local oscillators 605, one of the local oscillators 605 may be enabled at a time (while the other local oscillators may remain turned off). Subsequently, the phase of one of the local oscillators 605 may be selected as a reference phase, and the phase of the other local oscillators may be adjusted to be aligned with the reference phase. In some examples, the phase calibration using the IQ information may be performed when the phase noise tolerance for the multi-IC local oscillator 600 is above a threshold (e.g., during a retrace time, while a lower-order modulation technique is used, etc.). In some examples, the IQ detector 615 may also be capable of detecting an amplitude of the combined local oscillator signal generated by the multi-IC local oscillator 600. In some examples, the phase calibration using the IQ information may be performed while the multi-IC local oscillator is in an idle state or while a reduced modulation order is used. In some examples, the IQ phase calibration method may be used to display a phase noise spectrum, where the spectral display may be used to look for spurs from the synthesizer. In the case where a given phase shift causes spurs, a higher modulo of the required phase may be programmed for reduced spur levels.

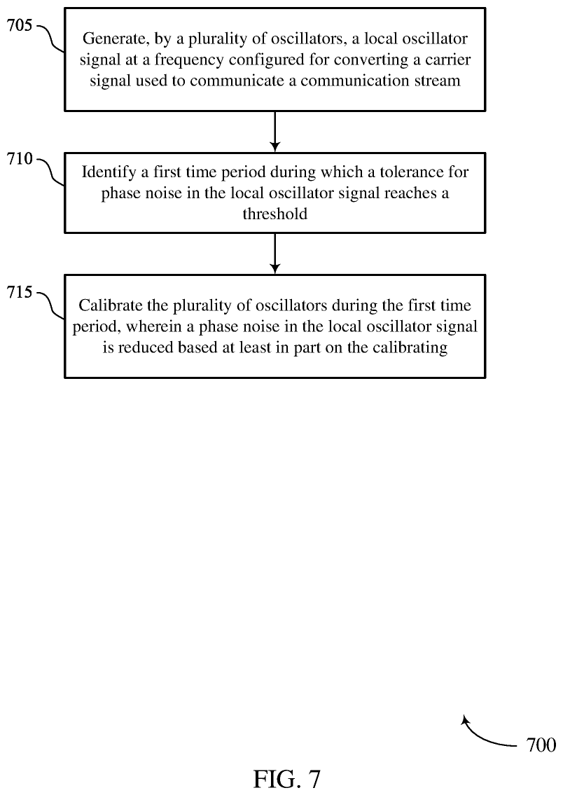

FIG. 7 shows an example of a set of operations for oscillator phase noise calibration in accordance with aspects of the present disclosure. The operations of the method 700 may be implemented by a communication system or its components as described herein. For example, the operations of the method 700 may be performed by a communication system as described with reference to FIGS. 1 through 7. In some examples, a communication system may execute a set of instructions to control the functional elements of the communication system to perform the described functions. Additionally, or alternatively, the communication system may perform aspects of the described functions using special-purpose hardware.

At 705, the method may include generating, by a plurality of oscillators (230), a local oscillator signal (260) at a frequency configured for converting a carrier signal (203) used to communicate a communication stream. The operations of 705 may be performed in accordance with examples as disclosed herein. In some examples, aspects of the operations of 705 may be performed by a multi-IC oscillator as described herein.

At 710, the method may include identifying a first time period during which a tolerance for phase noise in the local oscillator signal (260) reaches a threshold. The operations of 710 may be performed in accordance with examples as disclosed herein. In some examples, aspects of the operations of 710 may be performed by a calibration component as described herein.

At 715, the method may include calibrating the plurality of oscillators (230) during the first time period, wherein a phase noise in the local oscillator signal (260) is reduced based at least in part on the calibrating. The operations of 715 may be performed in accordance with examples as disclosed herein. In some examples, aspects of the operations of 715 may be performed by a calibration component as described herein.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

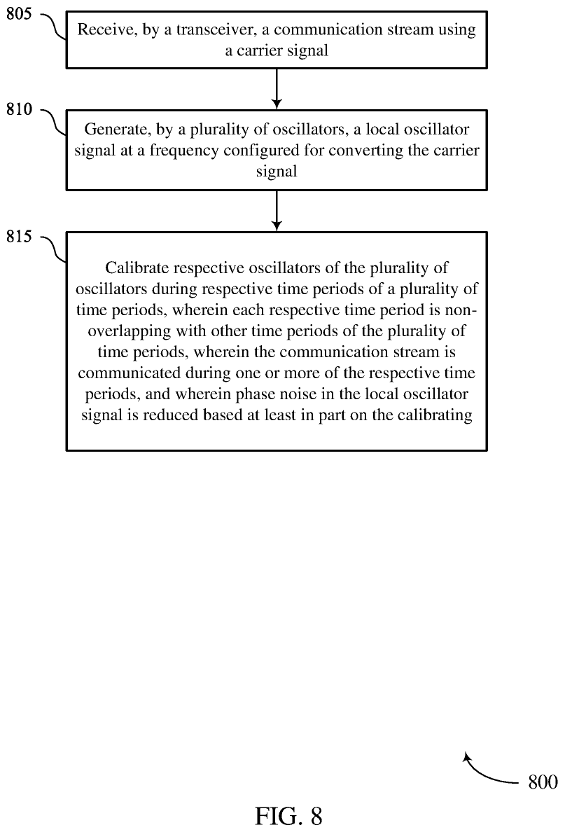

FIG. 8 shows an example of a set of operations for oscillator phase noise calibration in accordance with aspects of the present disclosure. The operations of the method 800 may be implemented by a communication system or its components as described herein. For example, the operations of the method 800 may be performed by a communication system as described with reference to FIGS. 1 through 4. In some examples, a communication system may execute a set of instructions to control the functional elements of the communication system to perform the described functions. Additionally, or alternatively, the communication system may perform aspects of the described functions using special-purpose hardware.

At 805, the method may include receiving, by a transceiver (214), a communication stream using a carrier signal (203). The operations of 805 may be performed in accordance with examples as disclosed herein. In some examples, aspects of the operations of 805 may be performed by a transceiver as described herein.

At 810, the method may include generating, by a plurality of oscillators (230), a local oscillator signal (260) at a frequency configured for converting the carrier signal (203). The operations of 810 may be performed in accordance with examples as disclosed herein. In some examples, aspects of the operations of 810 may be performed by a multi-IC oscillator as described herein.

At 815, the method may include calibrating respective oscillators (230) of the plurality of oscillators (230) during respective time periods of a plurality of time periods, wherein each respective time period is non-overlapping with other time periods of the plurality of time periods, wherein the communication stream is communicated during one or more of the respective time periods, and wherein phase noise in the local oscillator signal (260) is reduced based at least in part on the calibrating. The operations of 815 may be performed in accordance with examples as disclosed herein. In some examples, aspects of the operations of 815 may be performed by a calibration component as described herein.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer readable media may include RAM, ROM, electrically erasable programmable read-only memory (EEPROM), flash memory, compact disk read-only memory (CDROM) or other optical disk storage, magnetic disk storage or other magnetic storage devices, or any other non-transitory medium that can be used to carry or store desired program code means in the form of instructions or data structures and that can be accessed by a general purpose or special purpose computer, or a general purpose or special purpose processor. Also, any connection is properly termed a computer readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu ray disc where disks usually reproduce data magnetically, while discs reproduce data optically with lasers. Combinations of the above are also included within the scope of computer readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus, comprising:
an antenna;
a transceiver configured to communicate a communication stream via the antenna using a carrier signal;
a plurality of oscillators coupled with the transceiver, wherein the plurality of oscillators are configured to generate a local oscillator signal for converting the carrier signal; and
a calibration component configured to:
identify a first time period during which the plurality of oscillators can be calibrated without disrupting communication of the communication stream, wherein a threshold amount of phase noise permitted in the local oscillator signal is greater than a phase noise threshold during the first time period, and wherein the threshold amount of phase noise permitted in the local oscillator signal is less than or equal to the phase noise threshold during a second time period, and
calibrate the plurality of oscillators during the first time period, wherein a phase noise in the local oscillator signal is reduced based at least in part on the calibrating.

2. The apparatus of claim 1, further comprising:
a positioner coupled with the antenna, wherein the positioner is configured to:
point the antenna toward a first satellite during the second time period prior to a handover procedure from the first satellite to a second satellite, and
point the antenna toward the second satellite during a third time period after the handover procedure,
wherein the calibration component is further configured to identify that the first time period is between the second time period and the third time period.

3. The apparatus of claim 2, wherein the transceiver is configured to:
suppress communication of the communication stream during the first time period.

4. The apparatus of claim 1, wherein the transceiver is further configured to:
use a first modulation order during the second time period for communicating the communication stream; and
use a second modulation order during the first time period for communicating the communication stream based at least in part on an indication from the calibration component indicating the first time period, wherein the second modulation order is a lower modulation order than the first modulation order.

5. The apparatus of claim 1, wherein the carrier signal is a first carrier signal, the plurality of oscillators are a first plurality of oscillators, and the local oscillator signal is a first local oscillator signal, the apparatus further comprising:
a second plurality of oscillators coupled with the transceiver, wherein the second plurality of oscillators are configured to generate a second local oscillator signal for converting a second carrier signal, and wherein the calibration component is configured to calibrate the second plurality of oscillators with the first plurality of oscillators during a third time period during which the threshold amount of phase noise permitted in the second local oscillator signal is greater than the phase noise threshold; and
a controller configured to cause the transceiver to switch from the first local oscillator signal to the second local oscillator signal to communicate the communication stream based at least in part on calibrating the second plurality of oscillators with the first plurality of oscillators.

6. The apparatus of claim 5, wherein, during at least a portion of the third time period, the threshold amount of phase noise permitted in the first local oscillator signal is less than or equal to the phase noise threshold.

7. The apparatus of claim 1, wherein the antenna is a first antenna and the plurality of oscillators are a first plurality of oscillators, the apparatus further comprising:
a second antenna coupled with a second transceiver; and
a second plurality of oscillators coupled with the second transceiver, wherein a second local oscillator signal for converting a second carrier signal is generated by the second plurality of oscillators for communication of the communication stream via the second antenna.

8. The apparatus of claim 7, wherein:
the transceiver is configured to communicate first data packets of the communication stream via the first antenna during the second time period and to communicate second data packets of the communication stream via the second antenna during the first time period.

9. The apparatus of claim 1, wherein:
each of the plurality of oscillators generate a respective component local oscillator signal; and
calibration of the plurality of oscillators comprises reducing a phase difference between the respective component oscillator signals below a second threshold.

10. The apparatus of claim 9, wherein the calibration component is configured to:
determine a rate of increase of the phase noise in the local oscillator signal during a fourth time period; and
determine a periodicity for calibrating the plurality of oscillators based at least in part on the rate.

11. The apparatus of claim 1, wherein the calibration component is configured to:
calibrate, during the first time period, a first subset of the plurality of oscillators;
determine a third time period during which the threshold amount of phase noise permitted in the local oscillator signal is greater than the phase noise threshold, the third time period being non-contiguous with the first time period; and
calibrate, during the third time period, a second subset of the plurality of oscillators.

12. The apparatus of claim 1, wherein, to calibrate the plurality of oscillators, the calibration component is configured to:
align a phase of each of the plurality of oscillators with a common phase reference.

13. The apparatus of claim 1, wherein the plurality of oscillators each comprises an integrated circuit oscillator.

14. The apparatus of claim 1, wherein the plurality of oscillators each comprise a ring oscillator, a resonant circuit oscillator, or a combination thereof.

15. The apparatus of claim 1, wherein the antenna comprises an array of antenna elements, a parabolic antenna, or a combination thereof.

16. The apparatus of claim 1, wherein the calibration component is configured to:
calibrate, during the second time period, a first subset of the plurality of oscillators; and
calibrate, during a third time period during which the threshold amount of phase noise permitted in the local oscillator signal is less than or equal to the phase noise threshold, a second subset of the plurality of oscillators.

17-32. (canceled)
